(19) United States
(12) Patent Application Publication
(10) Pub. No.: US 2008/0028613 A1
(43) Pub. Date: Feb. 7, 2008

(54) Stand for display unit

(75) Inventor: Mitsuyoshi Takao, Kumagaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/790,195

(22) Filed: Apr. 24, 2007

(30) Foreign Application Priority Data
Jun. 20, 2006 (JP) 2006-170281

(51) Int. Cl. B23P 15/00

(52) U.S. Cl. 29/897

(57) ABSTRACT

According to one embodiment, a stand for a display unit is formed by machining one metal plate. Namely, this metal plate includes a fixing plate part fixed to a cabinet of a display unit, a flange formed by cutting and bending a part of the fixed plate part, a bottom plate part which is continued from the fixed plate part, and bent in the same direction as the flange, and a support plate part which is formed by bending a part of the bottom plate part, and connecting to the flange.

### CROSS-REFERENCE TO RELATED APPLICATIONS

This application is based upon and claims the benefit of priority from Japanese Patent Applications No. 2006-170281, filed Jun. 20, 2006, the entire contents of which are incorporated herein by reference.

### BACKGROUND

1. Field

One embodiment of the invention relates to a stand for a display unit, for example, a liquid crystal display and a plasma display.

2. Description of the Related Art

A stand assembly having a tilt mechanism to tilt a display surface has been known as a conventional stand for a display unit. It is disclosed by, for example, Jpn. Pat. Appln. KOKAI Publication No. 2006-30672. This stand assembly has a plate-like support bracket provided rotatably to a support base, and fixed to a display unit by inserting and securing the support bracket to a cabinet of a display unit with a screw. This stand assembly is characterized in that the structure can be fixed and removed without taking off a back cabinet of a display unit.

A panel size of a display unit has been increased in recent years, and a rigid stand assembly is demanded. However, if a support bracket is constructed with the same thickness, the bending strength of a support bracket is decreased when the support bracket area is increased to meet a panel size. The support bracket strength can be increased by increasing the thickness, providing a rib, or stacking two or more plates. But, these methods increase the weight of a whole stand assembly, and increase the material cost and the number of manufacturing steps. As a result, the total cost will be increased.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a front view of a stand as an example to be compared with the invention;

FIG. 2 is a perspective of the stand of FIG. 1 viewed from the rear side;

FIG. 3 is a developed view of one metal plate constituting the stand of FIG. 1;

FIG. 4 is a developed view of the other metal plate constituting the stand of FIG. 1;

FIG. 5 is a perspective view of the metal plate of FIG. 3 in a bent state;

FIG. 6 is a rear side perspective view of a stand according to an embodiment of the invention;

FIG. 7 is a front side perspective of the stand of FIG. 6 viewed from a display unit fixing side; and

FIG. 8 is a developed view of one metal plate constituting the stand of FIG. 6.

### DETAILED DESCRIPTION

Various embodiments according to the invention will be described hereinafter with reference to the accompanying drawings. In general, according to one embodiment of the invention, a stand for a display unit is formed by machining one metal plate. Namely, the metal plate includes a fixing plate part to be fixed to a cabinet of a display unit, a flange formed by cutting and bending a part of the fixing plate part, a bottom plate part formed by bending the lower edge portion of the fixed plate, and a support plate part formed by bending the bottom plate part and connecting the flange.

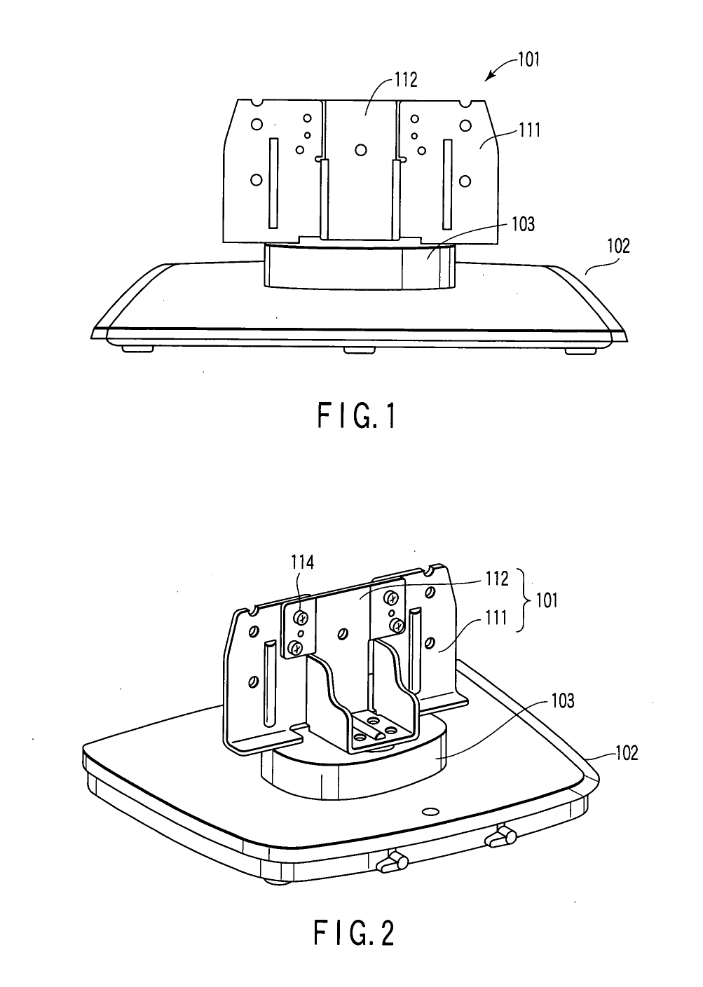

First, before explaining a stand for a display unit according to an embodiment of the invention, an example to be compared with the invention will be explained with reference to FIG. 1 to FIG. 5.

As shown in FIG. 1 and FIG. 2, a stand 101 as a comparison example is set up on a swivel mount 103 on a support base 102, and secured with a screw. The stand 101 is used to fix a not-shown display unit, such as a liquid display panel and a plasma display panel, which is supported rotatably in the left and right directions about a rotation axis extending substantially in a vertical direction. FIG. 1 is a front view of the stand 101 viewed from the display unit fixing side. FIG. 2 is a rear side perspective of the stand 101 viewed from the rear side. A display unit is not shown in these figures.

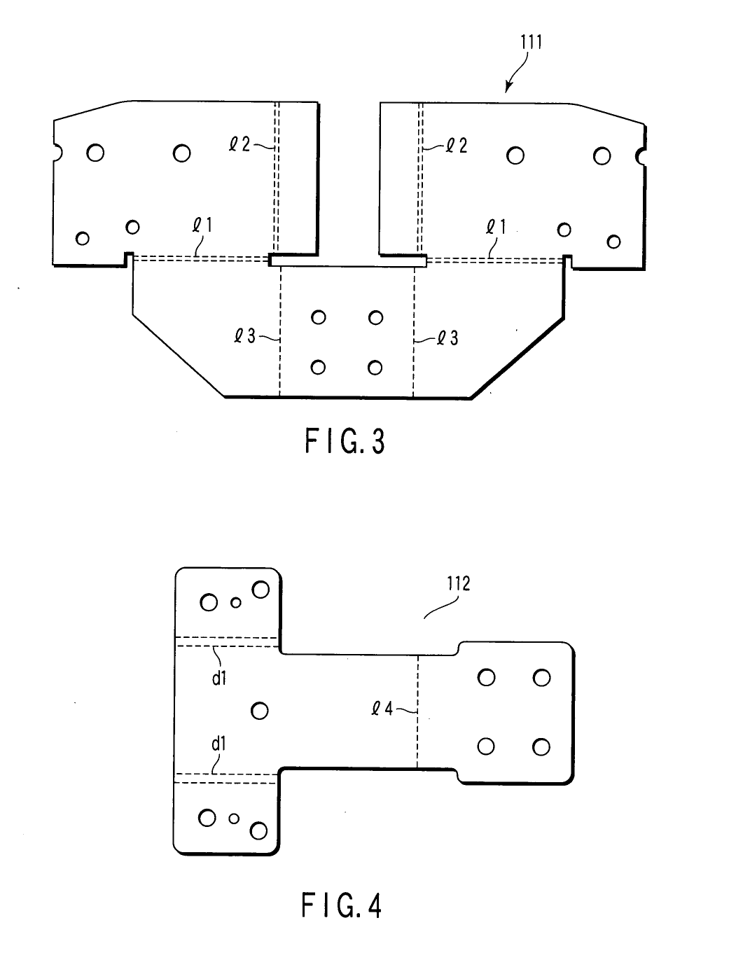

The stand 101 is formed by combining two metal plates shown developed in FIG. 3 and FIG. 4. One metal plate 111 of FIG. 3 is relatively larger and bent to the state shown in FIG. 5. Concretely, the metal plate 111 is bent to the rear side substantially at right angles along the areas indicated by the broken lines 11 and 12, and bent to the front side, or in the reverse direction substantially at right angles along the area indicated by the broken line 13. At this time, screw holes are formed in the metal plate 111, and ribs r1 and r2 formed, as shown in FIG. 5. The metal plate 111 is formed by shaping a metal plate of thickness 3.0 mm, for example, and weighs 495 g. The material yield of the metal plate 111 is 71.4%.

The other metal plate 112 shown in FIG. 4 is bent to the state shown in FIG. 2, and secured to the above-mentioned metal plate 111 with a screw. Concretely, the metal plate 112 is bent substantially at right angles along the area indicated by the broken line 14 in FIG. 4. At this time, there are formed screw holes in the metal plate 112, an elongated groove to escape the rib 2r of the metal plate 111, and step d1 to eliminate a level difference from the metal plate 111. Step d1 is provided to flatten a fixing surface that the stand 101 contacts a display unit. The metal plate 112 is formed by shaping a metal plate of thickness 1.2 mm, for example, and weighs 80 g. The material yield of the metal plate 112 is 48.3%.

As described above, the stand 101 is formed by partially stacking two metal plates 111 and 112, and securing them with screws 114 (FIG. 2), as shown in FIG. 2. The weight of the stand 101 formed by two metal plates 111 and 112 is approximately 575 g in this comparison example.

The strength of the stand 101 can be increased by stacking two metal plates 111 and 112, and the stand can bear an increased panel size. In particular, when a stand is constructed to turn a display unit secured to the stand in the left and right directions as in the stand 101 explained in this comparison example, it becomes necessary to make the horizontal length of the fixing plate part to fix a display unit long, and to increase the strength in the horizontal direction, compared with a conventional stand having the above-mentioned tilt mechanism.

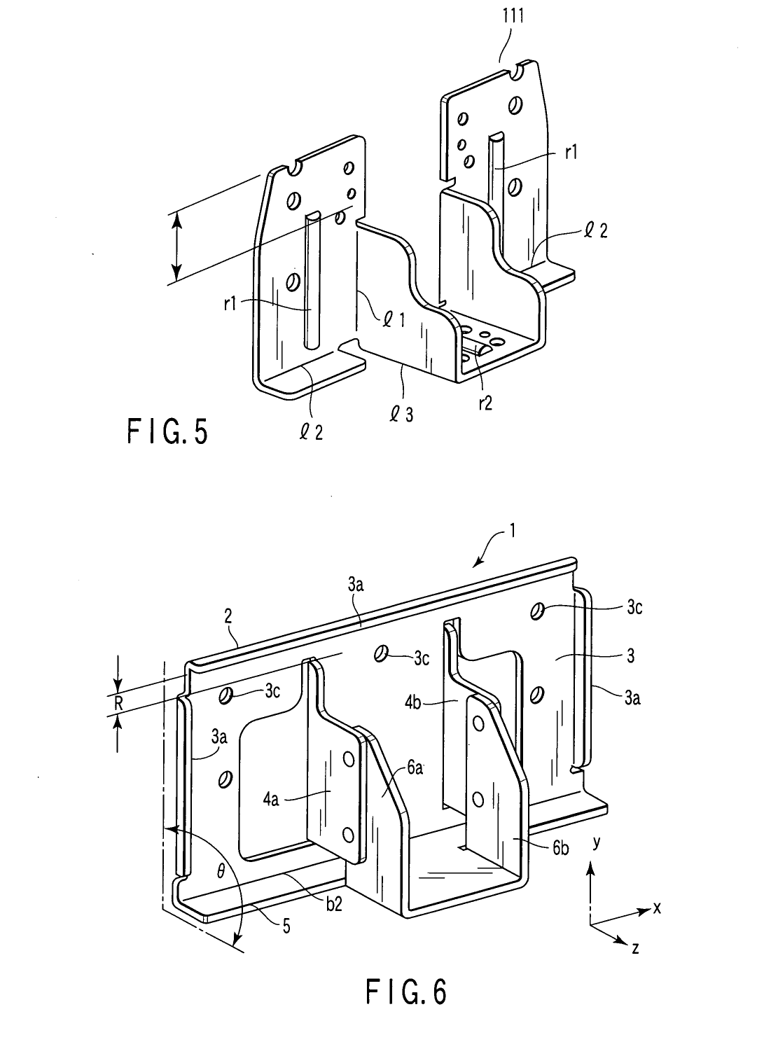

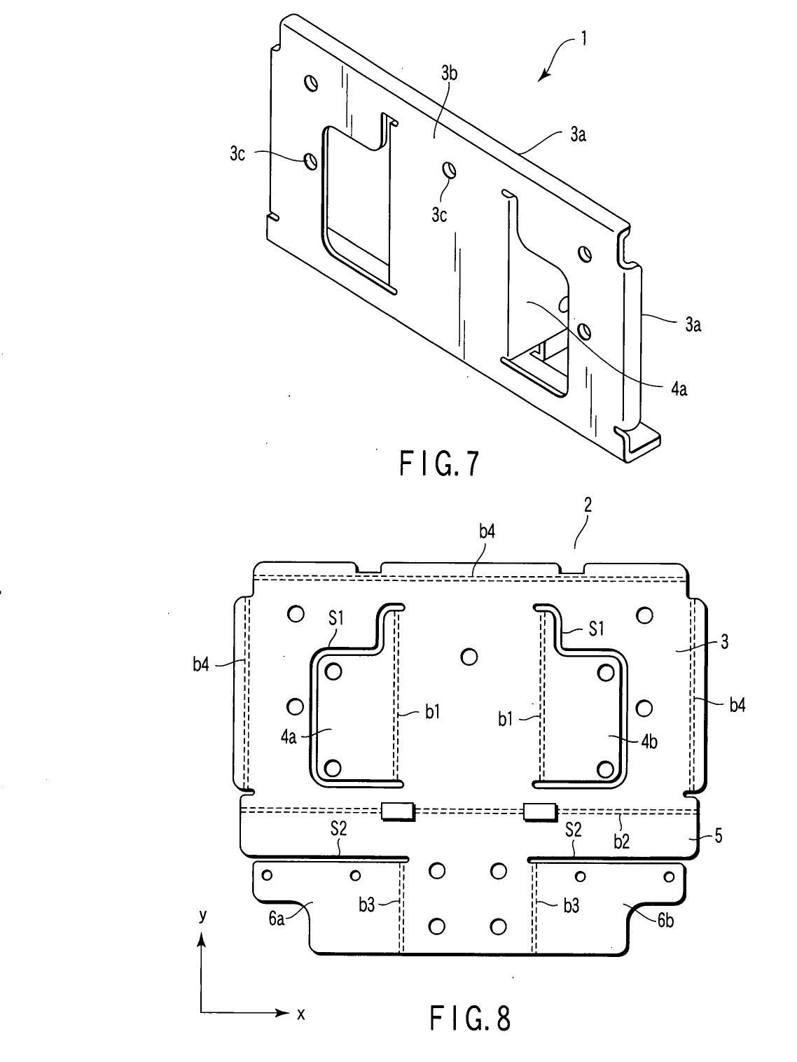

Next, an explanation will be given on a stand 1 for a display unit according to an embodiment of the invention modified from the stand 101 described above, with reference to FIG. 6 to FIG. 8. FIG. 6 is a perspective of the stand 1 viewed from the rear side. FIG. 7 is a perspective of the stand 1 viewed from a display unit (not-shown) fixing side. FIG. 8 is a developed view of one metal plate 2 before forming the stand 1. The stand 1, like the above described comparison example, is secured to a swivel mount of a not-shown support base with screws, and fixes and supports a not-shown display unit rotatably in the left and right directions.

The stand 1 is formed by cutting and shaping one metal plate as shown in FIG. 8, and by bending the shaped metal plate 2 at several areas and partially connecting them as shown in FIG. 6 and FIG. 7. Namely, the stand 1 of this embodiment is formed by shaping one metal plate, and bending the metal plate 2 several times in the same direction.

A manufacturing process can be simplified and a manufacturing cost can be decreased by bending one metal plate 2 in the same direction (here, to the front side in FIG. 8). Particularly, as shown in FIG. 8, the shaped metal plate 2 is substantially a rectangle, and the material yield is 86.9%. As the metal plate 2 is 2.9 mm thick in this embodiment, the weight is 570 g.

As shown in FIG. 8, after being shaped and removing unnecessary parts, the metal plate 2 has, on the same plane as one body, a fixing plate part 3 which is made contact with and fixed to a cabinet (not shown) at the rear of a display unit, two flanges 4a and 4b which formed by cutting a central area of the fixing plate part 3 except the peripheral part and bent substantially at right angles along a bending area b1 (first bending area) indicated by a broken line in the drawing, a bottom plate part 5 which is bent substantially at right angles along a bending area b2 (second bending area) in the lower end side of the fixing plate part 3, indicated by a broken line, and two support plates 6a and 6b which are formed by partially bending the bottom plate part 5 along a bending area b3 (third bending area) indicated by a broken line.

In other words, two flanges 4a and 4b are formed by cutting the peripheral edge portions (substantially three sides) along a slit s1 of the fixing plate part 3, and connected as one body to the fixing plate part 3 through the bending area b1. The bending areas b1 are extended in the direction of arrow y (first direction) that is substantially a vertical direction when the stand 1 is set to an operating state (the upright state as shown in FIG. 6), and positioned substantially parallel to each other, so that they are separated in the direction of arrow x (third direction) that is a horizontal direction when the stand 1 is set to an operating state. Namely, a rib structure can be formed at central two positions in the horizontal direction of the stand 1 in the state that two flanges 4a and 4b are bent substantially at right angles to the front side orthogonal to the directions of arrows x and y, or in the direction of z (second direction) (refer to FIG. 6).

Two slits s2 are formed between the bottom plate part and two support plate parts 6a and 6b, so that the two support plates 6a and 6b can be partially bent from the bottom plate part 5. The bending area b3 to bend two support plate parts 6a and 6b from the bottom plate part 5 is substantially on an extended line of the bending area b1 of the fixing plate part 3 along the direction of arrow y, and designed so that two flanges 4a and 4b and two support plate parts 6a and 6b are stacked on one another at 1:1. Actually, the bending area b3 is positioned to a place displaced to the direction of arrow x by the thickness of the flanges 4a/4b and support plate parts 6a/6b.

When forming the stand 1 by bending the metal plate 2 shaped as above, first two flanges 4a and 4b are bent to the front side in FIG. 8 substantially at right angles along the bending area b1, and at the same time, two support plate parts 6a and 6b are bent to the same side along the bending area b3 substantially at right angles. At this time, in the same process, an elongated rib 3a is formed (refer to FIG. 6 and FIG. 7) by bending three end sides, except the bending area b2 of the fixing plate part 3, substantially at right angles in the same direction along a bending area b4 indicated by a broken line in the drawing.

Then, the bottom plate part 5 is bent along the bending area b2 substantially at right angles to the fixing plate part 3, and two support plate parts 6a and 6b stacked on the insides of two flanges 4a and 4b, respectively. The flanges 4a and 4b are secured to the support plate parts 6a and 6b, respectively, with screws through the screw holes formed previously in the flanges 4a and 4b and the support plate parts 6a and 6b. The stand 1 is formed in this way. This state is shown in FIG. 6 and FIG. 7.

As described above, according to this embodiment, the stand 1 can be manufactured in a simple process of shaping and bending one metal plate, and in particular, the stand 1 can be formed by simply bending the shaped metal plate in the same direction in two steps. Therefore, the number of man-hours can be greatly decreased, the manufacturing process can be simplified, and the manufacturing cost can be decreased. Further, as described before, the material yield of the stand 1 of this embodiment is greatly improved compared with the above-described comparison example. This also contributes to the cost reduction.

Further, by making the stand 1 out of one metal plate 2, the contacting surface 3b (refer to FIG. 7) of the fixing plate part 3 to contact a display unit can be made flat, and the surface accuracy can be increased, and a display unit can be stably held without looseness. In contrast, the stand 101 of the comparison example is formed by stacking two metal plates 111 and 112, and the surface accuracy of the surface to contact a display unit is low, and looseness may occur.

According to this embodiment, in addition to the decreased number of parts and the improved material yield, the weight of the stand 1 can be reduced compared with the comparison example, and the strength of the stand can be held high. Namely, in the stand 1 which supports a display unit rotatably in the left and right directions, a stress in the horizontal direction is particularly large. Therefore, a desired strength can be held by providing a rib at two central positions and at a peripheral edge portion of the fixing plate part 3, as in this embodiment.

In the stand 1 of this embodiment, a vertical angle (tilt angle) of a display unit can be easily changed by the bending angle θ of the bending area b2 shown in FIG. 8. In contrast, in the stand 101 of the comparison example, the tilt angle cannot be changed because of its bending structure. Namely, the stand 1 of this embodiment has a high degree of flexibility in design.

In addition, in the stand 1 of this embodiment, a display unit is made contact with the contacting surface 3b of the fixing plate part 3, and secured with a screw. A plurality of screw holes 3c penetrating the fixing plate part 3 is provided for this purpose. These screw holes 3c cause a decreased strength of the stand 101, when they are provided in a place having no relation to a rib as in the comparison example. Thus, in this embodiment, a screw hole for a screw to secure a display unit is arranged at a position overlapping the rib 3a of the fixing plate part 3 with respect to the x and y directions, in order to prevent a decrease in the strength of the stand. For example, as shown in FIG. 6, the screw hole 3c is not provided in an area R not overlapping the rib 3a in the x direction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, in the embodiment described hereinabove, the flanges 4a and 4b, support plate parts 6a and 6b, and rib 3a are bent first in the metal plate 2 bending process, and then, the bottom plate part 5 is bent along the bending area b2. However, the order of bending the metal plate 2 can be optionally changed according to the manufacturing equipment.

Further, the rib 3a is formed in all three sides of the fixing plate part 3. However, the rib 3a may be provided at least one side of the fixing plate part. Two support plate parts 6a and 6b are connected to two flanges 4a and 4b in the embodiment. But, the number of flange 4 and support plate part 6 may be increased to three or more, when the panel size of a display unit is increased, for example.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A stand for a display unit formed by machining a substantially rectangular metal plate, comprising:
a fixing plate part which is made contact with and fixed to a cabinet of a display unit;
a flange which is formed by cutting a part of the fixing plate part except a first bending area extending in a first direction along the fixing plate part, and bending the cut part substantially at right angles along the first bending area in a second direction separating from the cabinet;
a bottom plate part which is continued from the fixed plate part as one body in the first direction, and bent at the lower edge of the fixed plate part substantially at right angles along a second bending area extending in a third direction substantially orthogonal to the first and second directions; and
a support plate part which is formed by bending a part of the bottom plate part substantially at right angles toward the flange, along a third bending area extending in the second direction along the bottom plate part, and connecting to the flange.

2. The stand for a display unit according to claim 1, wherein the flange is formed by cutting a central part of the fixed plate part except the peripheral part, and bending in the second direction along the first bending area.

3. The stand for a display unit according to claim 2, wherein the flange is provided in two or more separated from each other along the third direction.

4. The stand for a display unit according to claim 3, wherein the third bending area of the bottom plate part is on a substantially extended line along the first direction of the first bending area of the fixed plate part, and the support plate part is provided in the same number as the flange.

5. The stand for a display unit according to claim 4, wherein an elongate rib formed by bending the fixed plate part substantially at right angles to the second direction is provided in at least one side of the end sides of the fixed plate part except the second bending area.

6. The stand for a display unit according to claim 5, wherein a screw hole to insert a screw to secure the fixed plate part to the cabinet of a display unit is formed at a position to overlap the rib with respect to the first and third directions.

7. The stand for a display unit according to claim 1, wherein a bending angle between the fixed plat part and bottom plate part along the second bending area is variable.
